(19) United States
(12) Patent Application Publication
(10) Pub. No.: US 2007/0160501 A1
(43) Pub. Date: Jul. 12, 2007

(54) Device and method for treating a crystal by applying microdrops thereto

(75) Inventors: Torsten Neuefeind, Gauting (DE); Hans Brandstetter, Marzoll (DE); Reiner Kiefersauer, Neuried (DE)

Correspondence Address: KNOBBE MARTENS OLSON & BEAR LLP, 2040 MAIN STREET, FOURTEENTH FLOOR, IRVINE, CA, 92614, US

(73) Assignee: PROTEROS BIOSTRUCTURES GMBH, Martinsried (DE)

(21) Appl. No.: 10/567,193

(22) PCT Filed: Aug. 6, 2004
(86) PCT No.: PCT/EP04/08812

§ 371 Date: Sep. 11, 2006

(30) Foreign Application Priority Data
Aug. 6, 2003 (DE) 103 36 110.3

(51) Int. Cl. B01L 3/00

(52) U.S. Cl. 422/99

(57) ABSTRACT

The invention relates to a device for treating a crystal with a liquid having a holder for fixing the crystal and a micro dosage system, which, in relation to the holder, is arranged in such a way that it allows applying microdrops of the liquid onto the crystal fixed in the holder. Furthermore, the invention relates to a method for treating a crystal with a liquid, wherein the crystal is fixed and microdrops of the liquid are applied onto the crystal. The invention is particularly useful for gently treating protein crystals with specific substances. Thus, for example, ligands or inhibitors, which are contained in the liquid, can be applied onto the crystal by means of a piezo pipette. Herein, the crystal is preferably located in a defined gas atmosphere, to which an evaporated solubilizer for the ligand or inhibitor can be added.

The present invention relates to a device and a method for treating a crystal with a liquid and, in particular, to a device and a method for introducing ligands and/or inhibitors into a protein crystal structure.

In protein crystallography, it is often the case that ligands or inhibitors are to be introduced into a protein structure or a protein crystal before crystallographic measurement. Herein, the crystallographic structure of a protein with and without ligand or inhibitor is to be compared and the spatial arrangement of the ligand or protein is to be determined. Herein, all molecules or substances binding to a protein or to a polypeptide, which can, for example, have an inhibitory effect or an agonistic effect on the function of the protein, can act as ligands. Optionally, ligands can be organic chemical molecules or also (modified) antibodies or antibody fragments, native binding partners or fragments, optionally modified, of crystallized protein. Furthermore, heavy metal atom derivatives are regularly needed in crystallography in order to obtain the relevant phase information. A ligand in the sense of the present invention can therefore also be a heavy metal atom (salt) binding to the crystallized protein.

A method known in the art for introducing ligands, for example inhibitors, is the so-called “soaking” with a buffer consisting of crystallization solution and the ligand. In case a ligand to be soaked into the crystal is weakly or only hardly soluble, further substances acting as improvers of solubility can be added to the buffer in order to increase solubility. These substances can be, for example, solvents like DMSO (dimethylsulfoxide), TFE, ethanol, 2-nitropropane or other organic solvents, in particular chlorinated solvents, optionally also emulsifiers.

The soaking method has various disadvantages. Thus, one disadvantage is that, in the process of soaking, the crystals have to be exposed to a different environment, whereby the crystal may suffer damage, i.e., in particular, that the microstructure of the crystal shows irregularities after soaking, which impair its ability to diffract. If, for example, hardly soluble inhibitors or ligands are to be introduced into the protein crystal structure, very high solvent concentrations are needed. However, precisely high solvent concentrations often lead to destruction of the fragile protein crystals, as mentioned above.

Moreover, a further disadvantage of the conventional soaking method is its high expenditure of time. On the one hand, this is caused by the possibly numerous (repetitive) soaking processes, which, optionally with altered concentration ratios of the ligand to be soaked, have to be completed in order to obtain a suitable protein crystal structure (co-crystal), which contains the ligands or inhibitors, i.e. is complexed, at all, and on the other hand by the fact that one single soaking process can already be very time-consuming because, for example, diffusion kinetics have to be taken into consideration.

It is a further disadvantage of the soaking method that X-ray-crystallographic examinations or examinations of the protein crystal by means of synchrotron radiation are technically not feasible during the course of the soaking method.

It is now an object of the present invention to provide a device and a method for treating a crystal with a substance that, in comparison with hitherto existing devices and methods, inter alia, allows a gentler treatment of crystals and, in particular, protein crystals and a simpler and/or more efficient production of complexed crystals and, in particular, protein crystals as well as the simpler production of complexed crystals and, in particular, protein crystals, which could hitherto only be produced at great difficulties or not at all.

This object is met by means of a device for treating a crystal with a liquid having a holder for fixing the crystal and a micro dosage system, which is arranged in relation to the holder in such a way that it can apply microdrops of a liquid comprising, for example, a solvent and at least one type of ligand onto the crystal fixed in the holder.

By means of dripping on microdrops using the device according to the present invention, a substantially gentler treatment of crystals and, in particular, protein crystals with specific substances to be applied, which are contained in a solution, can be achieved. In the case of protein crystals, these substances can be ligands, for example inhibitors, substrates, or reactants. In the case of protein crystals, the ligands will typically be agonists, substrates, or antagonists of the crystallized proteins. Furthermore, according to the present invention, a system is provided for the first time, which allows complexing a crystal, in particular, a protein crystal, with a ligand irrespectively of the environment within a mother solution, like in all experiments according to the art. In this way, as according to the present invention, protein crystals can still form a complex, even in cases, which are not complexible with ligands by means of methods according to the art. The reason for the superiority of the method according to the present invention, which requires a freely mounted crystal and the provision of a micro (pico) drop by means of the use of a corresponding device, is the shift of balance of the reaction between ligand and crystallized protein to form complexed protein. In turn, this is connected with the reduction of the apparent dissociation constant K_{D}, as the concentration of the free component is considerably limited by the isolation of the protein crystals of the mother liquor surrounding the crystal (according to the state of the art). This reduction of K_{D} allows obtaining complexes even in cases when the binding constant of the ligand to the crystallized protein is actually low or the ligand is only weakly soluble and therefore methods according to the art (crystal in mother liquor) would yield no or only insignificant complexing (which is not sufficient for subsequent X-ray-crystallographic experiments).

Furthermore, it is of substantial significance not only to consider the shift of balance of the complexing reaction, which is advantageous according to the present invention, but also the advantageous kinetics of complex formation, which are facilitated by means of the system according to the present invention having a freely mounted crystal, in particular, in the case of weakly soluble ligands. The freely mounted crystal (without the environment of a mother solution) according to the present invention has a greater stability than the protein crystal soaked in mother solution according to the art. This increased stability can be used, for example, to force the complexing of the ligand, with the particularly preferred goal of at least 90%, preferably at least 95% saturation of the binding sites for the ligand, which are contained in the crystal, by means of the use of methods, for which a protein crystal in case of soaking or co-crystallization according to the state of the art would not be accessible.

Particularly preferable in this kinetic context is the use of ligand solution, which has been heated up to temperatures of more than 20° C., which is applied to the freely mounted crystal in the form of pico drops. This heating can, for example, amount to at least 30° C., preferably at least 40° C., more preferably at least 50° C. Heating up to 75° C. is also possible. Furthermore, or in combination with the heating of the ligand solution, said ligand solution, which is for example directly sprayed onto the crystal or is applied in the form of pico drops, can also contain or consist of organic solvents. Provided the organic solvent is soluble in water (for example DMSO or TFE), it can be contained at concentrations of at least 20 Vol-%, preferably at least 40 Vol-%, and more preferably at least 50 Vol-% in a mixture of water and the organic solvent. The ligand can also be solved in a purely organic solvent or in a mixture of different organic solvents and be applied onto the freely mounted crystal (see in the following) in the form of microdrops. The use of organic solvents, which in turn only becomes possible by the use of a freely mounted crystal and a microdrop according to the present invention, is particularly preferred if the ligands are only weakly soluble or insoluble in aqueous solution. Finally, the freely mounted crystal can be exposed to an evaporator stream, wherein organic solvent or an organic solvent mixture is evaporated via an evaporator. In this manner, the organic solvent, for example DMSO or chlorinated hydrocarbon is concentrated on/in the crystal and thus the solubility of the ligand hardly soluble in water is increased.

According to a particularly preferred embodiment, the crystal holder of the device for treating a crystal with at least one substance according to the present invention is developed in such a way that a gas stream, which is directed towards the crystal fixed in the holder, can be led through the holder. Thereby, the crystal can be kept in a defined environment during the treatment with the microdrops.

According to a further advantageous embodiment, a solubilizer (see supra), which, particularly in cases of hardly soluble ligands, considerably eases diffusion through the protein crystal or binding to the crystallized proteins, can also be added to the gas stream in case the crystal is a protein crystal and the substance in the liquid to be applied consists of solved ligands, for example inhibitors, which are to be introduced into the crystal structure of the protein crystal.

It is further particularly advantageous that the device according to the present invention can also be fixed onto a goniometer head in X-rays or in a synchrotron, so that the time-dependent course of the alteration of the crystallized protein structure, for example as a consequence of ligand binding during the application of the microdrops, can be monitored on the measuring device.

The object of the present invention is further solved by a method for treating a crystal with a liquid, wherein the crystal is fixed and subsequently microdrops of the liquid containing a solution and at least one ligand of a type are applied onto the crystal.

Further advantageous embodiments of the device according to the present invention and the method according to the present invention result from the dependent claims.

Preferred embodiments of the present invention are explained in the following with reference to the attached drawing.

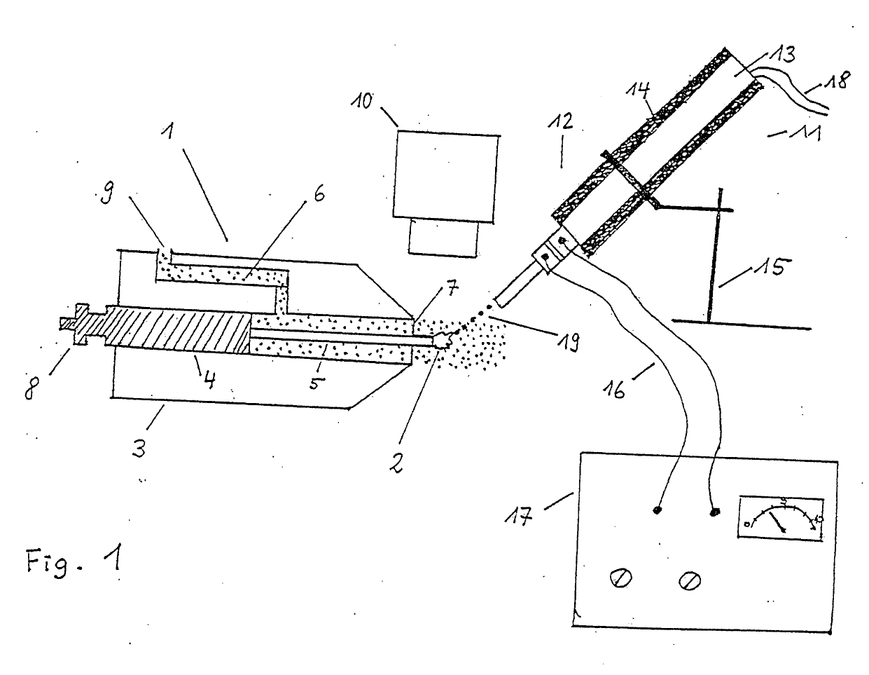

FIG. 1 shows a partially cross-sectional view of an embodiment of a device according to the present invention for treating a crystal with a solution.

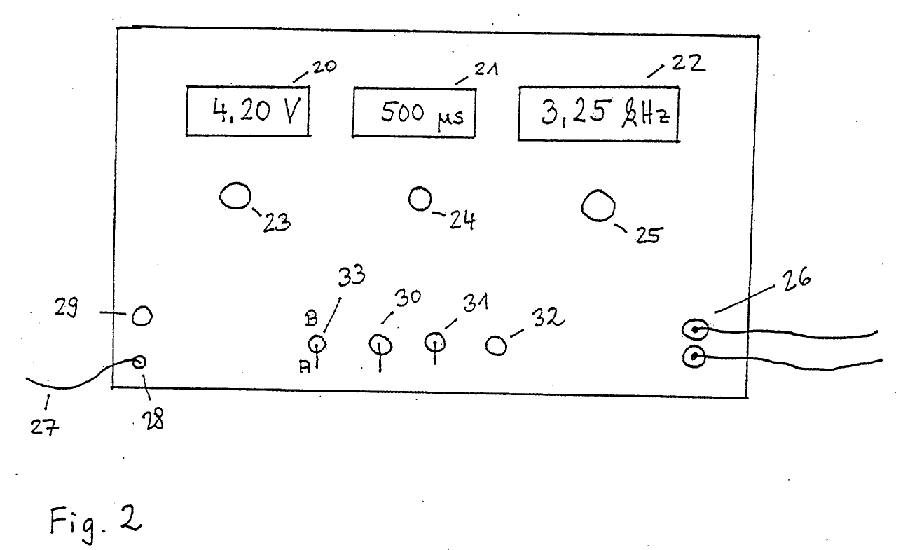

FIG. 2 shows a casing of a control device for controlling a micro dosage system used in an embodiment of the device according to the present invention.

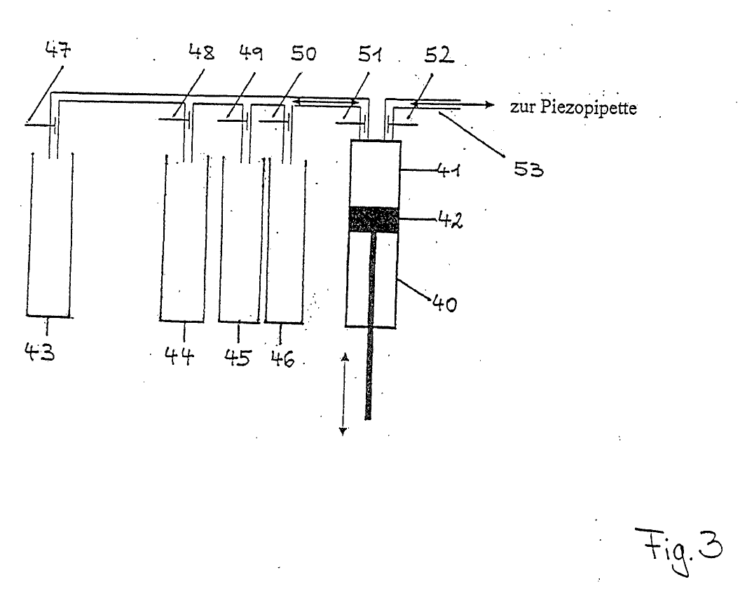

FIG. 3 shows a liquid supply system for a micro dosage system, which can be used in an embodiment of the device according to the present invention.

In the following, the present invention is described by way of the example of treating protein crystals; the invention can also be used analogously in the treatment of other crystals, however.

FIG. 1 shows a first embodiment of a device according to the present invention for treating a crystal. Herein, on the left hand side of FIG. 1, a holder 1 is depicted, which serves for fixing a protein crystal 2. The holder depicted in FIG. 1, which in its generic category is also referred to as free mounting system, is already known from the art and has been described, for example, in the German Patent Application DE 198 42 797 C1. In this respect, said document is incorporated into the disclosure of the present application to its full extent. In the sense of the present application, a freely mounted crystal is a crystal, which is not located in a liquid, as is, for instance, conventional according to the soaking method known in the art.

The holder 1, which is depicted in a lateral cross-sectional view in FIG. 1, substantially consists of a carrier block 3 having a plug-in insertion 4, which can be plugged into an opening of the carrier block 3. A holder capillary 5 is attached to the plug-in insertion, at whose free contact end the protein crystal 2 is held. The holder capillary preferably consists of a micropipette, in which, via a pumping device, which is not depicted in FIG. 1 and which is connected with the other end of the micropipette, a negative pressure is generated, which serves for holding the protein crystal 2 at the free contact end. The left end 8 of the plug-in insertion is developed in such a way that with it the holder 1 can be fixed to a goniometer head of an X-ray or synchrotron irradiation installation.

In an X-ray or synchrotron irradiation installation, the diffraction of X-rays can be utilized when passing through the crystal grid of the protein crystal in order to conclude the spatial arrangement of the atoms and molecules in the crystallized protein from the diffraction image or to calculate the structure by means of mathematical operations. The X-rays required can be generated, for example, by means of bombardment of copper or other materials with electrons (for example CuKα-radiation). Alternatively, the X-ray radiation can also be generated in a synchrotron, i.e. a particle accelerator, wherein the X-ray radiation is emitted by electrons accelerated in orbits. In spite of the greater equipment expenditure, the synchrotron still has various advantages compared to the conventional generation of X-ray radiation by means of electron bombardment of metals. Thus, the X-rays generated by means of synchrotrons have a higher intensity and can be selected in different wavelengths. In this manner, there is also the possibility of using “white” X-ray light and therefore of bombarding the crystal with X-ray flashes containing X-rays of all wavelengths. Furthermore, measurements can be conducted substantially faster with the synchrotron than with conventional X-ray irradiation installations.

Furthermore, a gas channel 6, whose mouth end 7 is directed toward the free contact end of the holder capillary 5, whereto the protein crystal 2 is fixed, is integrated into the holder 1. Herein, the protein crystal 2 attached at the contact end is enclosed entirely by the gas stream from the gas channel 6, so that a defined gas atmosphere can be generated around the protein crystal. At its end depicted as open in FIG. 1, the gas channel 6 is connected with a gas generating device and a gas mixing device, by means of which the composition of the gas stream can be adjusted variably. In case the gas surrounding the protein crystal is air, the gas mixing device can, for example, serve for regulating the air humidity to a predetermined optimal value. Furthermore, a temperature regulating device can be provided, by means of which the temperature of the gas stream can be measured and regulated to a specific value, which can be predetermined. Other gaseous substances can also be added to the gas stream, so that, for example, the nitrogen or oxygen content of the air can be modified, for example increased.

In the German Patent Application No. 102 32 172.8-52 having the title “Device and method for generating a defined environment for particle-shaped samples” (Vorrichtung und Verfahren zur Erzeugung einer definierten Umgebung für partikelförmige Proben), a device and a method have already been described, by means of which a highly exact and long-term stable humidity adjustment of a humid gas stream led through the above-described holder at the site of the particle-shaped crystal can be achieved. This document is therefore also incorporated into the disclosure of the present invention to its full extent.

A microscope having a video system 10, by means of which the protein crystal can be monitored during treatment with the substance, is mounted above the crystal. As a result of the monitoring via the video system, the mode of treatment can optionally be modified or the treatment can also be discontinued.

Furthermore, the device according to the present invention for treating a crystal with a substance comprises a micro dosage system 11, which is depicted on the right hand side of FIG. 1 in a lateral cross-sectional view.

The micro dosage system 11 comprises a so-called piezo pipette 12, which is held in a tripod 15 and is directed toward the protein crystal 2 in such a way that the latter can be bombarded with drops via the piezo pipette. For reasons of clarity, the piezo pipette is depicted in a magnified scale in relation to the holder 1 in FIG. 1. The piezo pipette is arranged in such a way that the tip of the piezo pipette has a distance of typically 3 mm from the protein crystal. Preferably, this distance lies within a range of 1 to 5 mm; it can, however, be selected smaller or greater under particular circumstances.

The piezo pipette 12 consists of a glass capillary 13, which can, for example, consist of borosilicate glass. The diameter of the opening of the glass capillary is one of the factors, which influence the size of the microdrops released from the piezo pipette, and can, for example, lie within a range of 5 and 50 micrometers. The glass capillary 13 is enclosed by a piezoelectric element 14 consisting of a material, which shows a piezoelectric effect. This material can, for example, be a piezocrystal. Furthermore, the piezoelectric element 14 is electrically connected via two cables with a controlling device 17, by means of which a voltage can be applied to the piezoelectric element 14. If a voltage pulse is applied to the piezoelectric element 14 via the controlling device 17, the piezoelectric element 14 and with it also the glass capillary 13 are contracted and a drop is shot out of the opening of the piezo pipette. Via the controlling device 17, differently shaped voltage pulses can be applied to the piezo pipette, whose shapes influence the shape and size of the microdrops and whose frequencies influence the frequency of the microdrops.

In FIG. 2, a casing of a possible controlling device for controlling the piezo pipette is depicted, wherein the individual controlling possibilities are to be explained by means of the switches and controlling elements of the controlling device, which are depicted in FIG. 2. Firstly, the controlling device has three different LCD displays 20, 21, and 22. On the first LCD display 20, the current value of the voltage level of the pulse output voltage for the control signal of the piezo pipette is indicated. This value can be adjusted variably via an adjustable transformer 23. The pulse amplitude of the control signal of the pipette, which is indicated in microseconds on the second LCD display 21, can be adjusted by means of a second adjustable transformer 24. Finally, a third adjustable transformer 25 is provided in order to adjust the frequency of the voltage pulses applied to the piezo pipette, which is indicated on the third LCD display 22. This frequency, which can amount to up to several kHz (for example 2 kHz), corresponds to the frequency, at which the microdrops are flung out of the piezo pipette onto the crystal. The adjustment range of the frequency can, for example, lie within a range of 1 Hz to 6 kHz. Firstly, the level of the pulse output voltage and the amplitude of the voltage pulses have to be adjusted in such a way that drop generation by means of the piezo pipette occurs at all. Then, the frequency, which is ideal for the corresponding crystal treatment process, is selected. Of course, the frequency can continuously be varied during the crystal treatment process.

Furthermore, the controlling device has two openings 26, whereto the two connecting cables of the piezo pipette are connected. Furthermore, a power cable 27 as well as a power connection 28 for power supply of the controlling device is provided. Via the further signal access 29, voltage pulse sequences predetermined by other electric devices can be applied in order to trigger microdrop formation and to regulate the sequence and shape of microdrops externally. This can, for example, be appropriate if there is a central controlling device, which regulates both drop generation and other parameters of crystal treatment, like the gas stream fed in via the crystal holder, the composition of the gas stream (for example its humidity content), the temperature of the gas stream, a connected X-ray irradiation installation etc., and which synchronizes the different control parameters in a predetermined manner.

The switch 30 is provided for switching the operation of the piezo pipette on and off. A further switch 31 allows switching between single voltage pulse operation and continuous voltage pulse operation, i.e. between single drop generation and continuous drop generation. For single drop generation, a caliper 32 can further be provided, via which single voltage pulses can be applied to the piezo pipette, if it is desired to shoot single drops onto the crystal in manual operation.

Finally, the switch 33 serves for being able to vary between different forms of impulse of the voltage pulses applied to the piezo pipette 12. In switch position A, for example, a predetermined standard square wave voltage pulse of predetermined duration and height can be generated, while in switch position B a square wave voltage pulse can be generated, whose duration and height can be adjusted variably. In other embodiments, it is, of course, also conceivable that voltage pulses are applied, which deviate from the square form. Now, the impulse shape of the voltage pulses is selected in such a way that optimal drop generation with respect to the crystal to be treated is ensured.

Different sizes of the microdrops, which can, for example, be suitable for different crystal sizes, can be adjusted via the variation of the voltage pulse amplitudes and voltage pulse heights, which the voltages applied to the piezo pipette exhibit.

The glass capillary 13 of the piezo pipette 12 is typically connected via a supply duct 18 with a supply container, which is not depicted in FIG. 1 and which contains the solution to be dripped onto the protein crystal. Said solution contains the substance or the substances the protein crystal is to be treated with. Herein, the top level of the liquid in the supply container should be adjusted slightly higher than the lower edge of the pipette tip. Alternatively, in an embodiment without supply container, the liquid can also be sucked directly via the outlet opening of the piezo pipette into the piezo pipette, in order to be able to release it again later.

A tempering device can also be arranged around the supply container, in order to bring the liquid in the supply container to the desired temperature. According to one embodiment, the pH-value and/or the ionic strength (or specific salt concentrations) of the solution can, according to the methods known in the art, be adjusted to a desired value before applying the solution onto the crystal.

In the sense of the present invention, microdrops should be understood to denote drops, whose volume is smaller than 1 nl, wherein the volume of the microdrops preferably lies between 1 nl (nanoliter) and 1 pl (picoliter), further preferably between 100 pl and 20 pl, and even more preferably between 20 pl and 4 pl. By use of the volume formula, the corresponding suitable diameters of the drops can be calculated from these quantities, if the drops are approximately assumed to be of globular shape. According to the present invention, the desired size of the drops can be adjusted.

Herein, the microdrops of the liquid to be applied onto the crystal are preferably smaller than the volume of the crystal. Herein, a typical volume of a crystal can, for example, be in an order of magnitude of about 1 nl.

The volume of the microdrops used in a specific case is selected in dependency on the volume of the crystal. Herein, the volumina of the microdrops are smaller than 50%, for example 1 to 20%, of the crystal volume and preferably 1, more preferably 5 to 10% of the crystal volume.

Drop generation by means of a piezo pipette is only one example for a micro dosage device. Other devices, which are capable of generating microdrops, can also be used.

Thus, for example, a micro dosage system comprising a capillary and a micro valve arranged inside said capillary can also be used. Herein, the liquid is squeezed under pressure from a supply container onto the micro valve, which is electrically opened and subsequently closed again by means of a controlling device, in order to generate the drops. Herein, the limitation of drop size results from the still controllable opening period of the valve.

In another embodiment, an atomizer can also serve as micro dosage system. In comparison with the above-described solutions, however, an atomizer has the disadvantage that the orientation of the drops toward the crystal is more difficult. Therefore, a device ensuring the orientation of the microdrops obtained from the atomizer toward the crystal is arranged behind the atomizer.

According to a further embodiment of the device according to the present invention, it is also conceivable that the micro dosage device consists of a loop, by means of which individual drops (or only one single drop) are applied onto the crystal by, for example, shaking off or dripping off the loop. However, in this solution of the problem underlying the present invention, it has to be ensured that the applied drop volumina are small enough for the protein crystals (in the sense of the above-disclosed volume ratios of crystal to drop).

All further technical possibilities of generating microdrops of corresponding sizes are also solutions in the sense of the present invention.

In order to be able to vary the frequency of applying the microdrops onto the crystal, an aperture plate, which, for example, rotates at a specific frequency, can be arranged between the device for generating drops and the crystal. As—depending on the device for generating drops—the provision of small microdrops often requires a higher drop frequency, the volume applied to the crystal can also be regulated via an aperture plate, which only lets every 2^{nd}, 3^{rd}, or 4^{th} drop pass through onto the crystal.

In one embodiment of the method according to the present invention, a protein crystal is firstly fixed at the free support end of the holder capillary 2. Instead of the holder capillary 2, a loop, in which the protein crystal is fixed, can also be used. Herein, the protein crystal is free of any kind of surface solution and is therefore accessible for solutions, which can be applied directly by means of the micro dosage system from the outside. By means of the holder 1, a gas atmosphere is now typically generated around the protein crystal 2 by leading a gas stream of defined composition and temperature through the gas channel 6 of the holder 1. In the method described, this will typically be an air stream, optionally with the addition of other gaseous substances, having a regulated humidity content (i.e. water content) and a regulated temperature.

An inhibitor, which is a component of a substance that has been added to the solution, which is located in the supply container connected with the piezo pipette, is now to be introduced into the crystal structure of the protein crystal. By way of experimentation, it has shown that solutions (like for example DMSO) having high inhibitor concentration and being locally applied onto the surface of the crystal do normally not damage the crystal. Now, electric voltage pulses are applied to the piezo pipette 12 by means of the controlling device 17 and microdrops with the inhibitor solution are flung onto the protein crystal 2. The gas stream streaming around the protein crystal remains practically unaffected by the spraying of individual microdrops, so that the protein crystal remains within its stably defined environment. The preservation of a stable environment is of particular importance for the relatively unstable protein crystals, which are held together by low lattice binding forces, in order to prevent the crystals from being destroyed when they, for example, undergo an X-ray crystallographic examination. The humidity of the air stream surrounding the crystal can now, in interplay with size and frequency of the drops applied onto the protein crystal via the micro dosage device, be adjusted in such a way that, if possible, the crystal changes its volume only slightly by means of achieving a balance between evaporation of liquid from the crystal and accumulation of liquid by dripping on liquid by means of the micro dosage device. Thereby, the crystal is strained only minimally and a gentler introduction of the ligand/structure via the locally applied microdrops can be achieved. This process of adjusting the optimal air humidity or the optimal dripping-on frequency by means of the micro dosage device can be regulated automatically via a regulating element, which correspondingly alters the humidity of the air stream and/or the dripping-on frequency in case the measured volume of the crystal changes. Herein, the goal is to keep the volume of the crystal as constant as possible, i.e. the volume typically deviates from the original volume by no more than 40%, preferably no more than 20%, particularly preferably no more than 10%. Herein, the volume alteration can be measured by means of field projection.

During the crystal treatment process, the crystal can, according to a preferred embodiment of the invention, also be irradiated with pulsed light, for example by means of a stroboscope, in order to be able to conduct a measurement of the volume of the drop at regular intervals via the video system.

According to a further embodiment of the invention, it is also conceivable that the crystal, which is located in the gas stream of defined composition, is surrounded by a solution, so that the drops applied by means of the micro dosage device are not applied directly onto the crystal, but into the solution surrounding the crystal.

The device according to the present invention and the method according to the present invention, respectively, also present themselves as particularly advantageous in cases where ligands, for example inhibitors or other substances, which are hardly soluble even in an aqueous solution, are to be introduced into a crystal. Actually, a variety of ligands are especially hard to solve in aqueous systems, so that said ligands/inhibitors cannot be introduced into the crystal by means of the classis soaking method, which was described in the introduction of the description, as the concentration of ligands/inhibitors in the aqueous solution is too low. If now an aqueous solution, wherein said ligands and/or inhibitors are solved, is dripped onto the crystal by means of the micro dosage system, the water will evaporate completely after each dripping-on, while the ligand remains on or in the crystal. By means of repeated dripping-on cycles, larger amounts of the (hardly soluble) ligand can thus be applied onto the crystal. Thus, the ligand will accumulate gradually on or in the crystal until a sufficient amount of ligand is introduced into the crystal and a satisfactory ligand-protein complex formation is achieved (i.e. until the occupation of the crystal at the binding sites of the crystallized protein is sufficient for determining an electron density for the ligand).

It is also an advantage of this method that the protein crystals do not have to be mixed with a further solvent and thus the treatment of the sensitive crystals becomes gentler. In this manner, it is furthermore prevented that the ligand precipitates on the crystal or in the solvent channels due to its weak solubility. In this method, the amount of solution to be dripped on by means of the micro dosage system can be calculated from the concentration of the solution as well as from an estimation of the molarity of the protein in the crystal. It is a further advantage of the method that particularly small drop sizes can be achieved with water as the only solvent for the ligand in comparison with other solvents or liquids, which is particularly important in the case of small protein crystals, as, according to the present invention, the drop size should be smaller than the size of the crystal.

The device according to the present invention for treating a crystal with a substrate can also be integrated into an X-ray irradiation installation or synchrotron irradiation installation, so that it becomes possible to record diffraction images of the crystal during treatment of the protein crystal with the substance, i.e. to monitor the successive occupation of the binding sites of the crystal “online”. To this end, the holder 1 can, for example, be fixed at a goniometer of an X-ray or synchrotron irradiation installation. The protein crystal can also be frozen before the X-ray crystallographic examination, which is normally conducted using liquid nitrogen (so-called cryo-crystallography). Hereby, in the case of X-ray crystallographic examinations, the intensities of the reflexes of the diffraction image are determined and finally the electron density of the structure can be determined by using the phase information, for example, from isomorphic substitution or MAD (multiple anomalous scattering).

Of course, other physical, in particular spectroscopic, measurements can also be conducted at the crystal with the aid of the device according to the present invention. Thus, the device according to the present invention can, for example, also be combined with an installation for recording an absorption spectrum in order to record the absorption spectrum of the crystal.

According to a further preferred embodiment of the invention, a solubilizer, which is suitable for the substance to be introduced into the crystal, i.e. for example a solubilizer for a hardly soluble ligand, can also or exclusively be added to the gas stream led through the holder 1. To this end, an evaporator can additionally be provided in order to evaporate the solubilizer before leading it into the gas channel 9 of the holder 1. A device serving for variably adjusting the concentration of the solubilizer in the gas stream and adapting it to the required conditions can also be provided. In this manner, a very gentle feeding of solubilizer to the protein crystal, in comparison with the classic soaking process, can be achieved. During the feeding of the gas stream containing the solubilizer, the ligand solution can then be applied onto the protein crystal via the piezo pipette in the form of microdrops. Altogether, according to the present invention, the possibility thus arises of adding solubilizer only to the ligand solution to be applied in the form of microdrops or only to the fed gas stream. Optionally, both alternatives can be combined, so that the solubilizers (identical or different) are added both in the microdrop and in the gas stream.

Herewith, according to the present invention, ligands, which cannot be bound by means of classic soaking processes, can be bound to the crystal. In addition, such a method according to the present invention requires, in comparison with hitherto existing soaking processes, less expenditure of time, as, due to the gentler crystal treatment, fewer attempts have to be made in order to complete the crystal treatment successfully.

The device according to the present invention as well as the method according to the present invention are not only suitable for introducing ligands into protein crystals, however. A variety of different treatment methods with different solutions can also be conducted with protein crystals in the manner according to the present invention.

The solution applied via the microdrops by means of the micro dosage system can also contain several different substances the crystal is supposed to be treated with. These can, for example, be several ligands, for example several substrates, or a substrate and a ligand acting catalytically, which are solved in a solution, which is to be applied onto the crystal by means of a piezo pipette.

According to a further embodiment, the piezo pipette can also be equipped with a special liquid supply system, with which it is possible to control the feeding of different liquids into the piezo pipette time-dependently in a desired manner. FIG. 3 depicts such a liquid supply system. The liquid supply system depicted in FIG. 3 comprises a precision syringe 40, which consists of a cylinder 41, wherein a piston 42 driven by a motor (not depicted in FIG. 3) can move up and down. If the piston moves downward, different liquids from the liquid containers 43, 44, 45, or 46 can be sucked into the cylinder, if one of the corresponding electrically controllable valves 47, 48, 49, or 50 is opened and, in addition, the electrically controllable valve 51 located in front of the cylinder is opened. If the valve 51 is then closed again, if the electrically controllable valve 52 located at the outlet of the cylinder is opened, and the piston 42 is driven upward, then the liquid sucked in can be led to the piezo pipette via the liquid supply duct 53 leading to the piezo pipette in order to then be finally able to be applied onto the crystal in the form of drops.

The containers 45 and 46 can, for example, contain two different solutions with different ligands, which are to form a complex with the protein of the crystal to be sprinkled. Herein, the treatment of the crystal can, for example, be conducted in such a way that firstly the solution 1 from the container 45 and subsequently the solution 2 from the container 46 are dripped onto the crystal. In between the two solutions, a cleaning solution, which is located in the container 44, can be flushed through the ducts. The further container 47 serves as waste container in order to take up those amounts of liquid, which are not needed anymore and have to be removed from the supply system. By means of suitable time-dependent activation of the valves 47-52 and of the piston 42, the desired solutions in the desired amounts can be delivered to the piezo pipette.

A further example for the use of a method according to the present invention is the so-called back soaking, wherein specific substances, which are already bound to the crystal structure of the protein, are substituted by other substances; i.e. a co-crystal is soaked again with the goal of a substitution. Thus, for example a ligand can be replaced by another ligand, which is contained in the solution, which is applied onto the protein crystal via microdrops.

Furthermore, the method according to the present invention can also be used for applying so-called cryo buffers onto a protein crystal (complexed or not complexed) in a very gentle manner. For reasons of stability, many protein crystals have to be frozen before the X-ray crystallographic examination, which is, as was described above, normally conducted using liquid nitrogen. During the freezing process, the cryo buffers are used in order to prevent the formation of ice, which would lead to the destruction of the protein crystal. Examples for cryo buffers are glycerin or 2-methyl-2,4-pentanediol (MPD). The cryo buffers can be filled into the supply container of the piezo pipette and then be sprayed onto the crystal by means of the micro dosage device similarly to the ligand solution.

According to a further embodiment of the invention, several micro dosage systems, for example several piezo pipettes, can also be used, by means of which different or identical substances (for example at two different locally defined regions of the crystal) are applied onto the crystal in each case. Such an arrangement can be of advantage, for example if two different ligands are to be introduced into a protein crystal structure. Said ligands are then solved in different solutions, which are filled into both liquid supply containers of two piezo pipettes. The two solutions are then applied onto the protein crystal in the form of microdrops via the two piezo pipettes. Herein, different voltage pulses and voltage pulse sequences can be applied to the piezo pipettes via the controlling device, which is connected with a piezo pipette in each case and which controls the generation of drops, in order to achieve optimal shape and frequency of the microdrops, which is ideal for the corresponding ligand.

The use of two micro dosage systems, by means of which two different substances, which only come together on the crystal, are applied separately, is also particularly advantageous, if the crystallized protein acts as catalyst for the two substances, which are both bound as reactants in the crystallized protein. If the spraying of both reactants is conducted separately by means of two micro dosage systems during the X-ray irradiation of the protein crystal, the reaction of the reactants can be traced by means of using the crystallized proteins as catalysts. The stability of the crystal is, of course, a prerequisite for such an X-ray crystallographic examination, i.e. the crystal must not lose its structure by structural shift of the crystallized proteins, as it would thereby also lose its diffraction ability.

The so-called cryo soaking can also be conducted in a particularly advantageous manner by means of the method according to the present invention. Cryo soaking is characterized in that the addition of ligands and the simultaneous freezing of a protein crystal are combined. In this manner, for example, transitional fomms of the protein crystal can be frozen and subsequently examined X-ray crystallographically. To this end, a system operating with several micro dosage systems can also be used, wherein, for example, the above-described cryo buffer is applied onto the protein crystal via one micro dosage system, and a solution, which contains the ligand to be introduced into the protein crystal, is applied in the form of microdrops onto the protein crystal via the other micro dosage system.

A further use would be, for instance, the spraying of reactants, which react with the protein crystal in a specific manner.

According to a further embodiment of the method according to the present invention, it is also conceivable that specific substances, which the crystal is to be treated with, are added to the gas stream, which is led through the holder for the crystal. Thus, for example, a ligand, which is to be introduced into the protein crystal structure, could be added to the gas stream in the process of soaking, while a solvent for this ligand is dripped on via the micro dosage system, or a solution is dripped on, in which a further ligand, which is to be integrated into the crystal structure of the protein crystal simultaneously with the ligand fed via the gas stream, is solved. The solvent for the ligand can, of course, also be additionally fed to the crystal via the gas stream. To this end, an evaporator can be used in order to transfer the solvent to a gaseous phase beforehand. A ligand to be fed via the gas stream can also be fed to the gas stream via the evaporator. In the above-described process of cryo soaking, a solvent containing ligand can also be fed to the protein crystal via the gas stream, while a cryo buffer is dripped onto the micro crystal via the micro dosage system.

In a preferred embodiment of the present invention, a method according to the present invention can also be used, by way of high throughput, for identifying compounds, which have complex formation properties. To this end, methods according to the present invention are suitable, wherein a crystal, as for example in DE 198 42 797 C1 or shown in FIG. 1, is mounted and (a) a potential ligand is applied onto the crystal by means of a method according to the present invention, (b) diffraction intensities are measured at variable time intervals, wherein at least one image, preferably 2 to 10 images, are taken at each point in time, and (c) said diffraction intensities, which typically represent different accumulation states of the potential ligand on the crystal and which are measured at intervals, are compared with respect to their time-dependent sequence. Herein, it is particularly preferred, if the crystal retains the same orientation during all of the diffraction recordings. In this manner, according to the present invention, it becomes possible to detect complex formation by means of only one crystal and individual X-ray images (without having to compile a complete data record) and therefore to identify the test substance as ligand or as non-binding. For, as complex formation increases, the correlation to the entirely unoccupied original state of the crystal decreases, as a result of which the differences in intensity (growing at intervals) of the reflexes indicate complex formation. Such a method can be conducted as high throughput method, as a non-binding substance can be discarded and the method can be repeated with another substance according to steps (a) to (c). According to the present invention, a test substance can be identified as ligand or be discarded as non-binding within a few minutes.

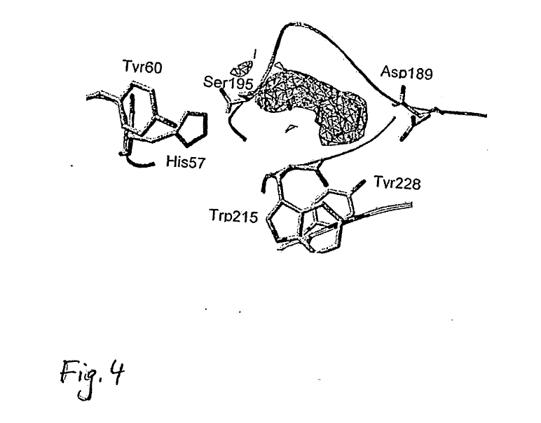

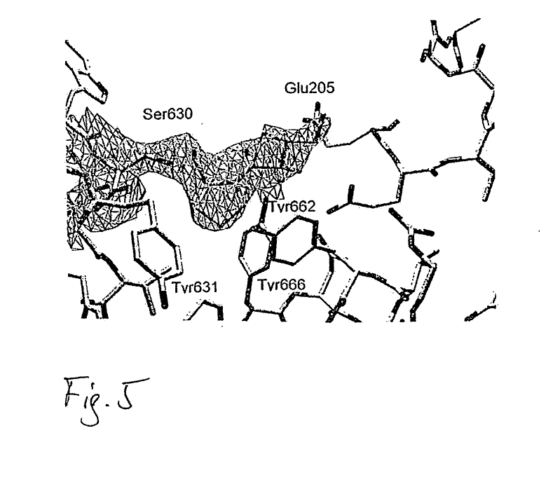

The present invention is explained in more detail by means of the FIGS. 4 and 5.

FIG. 4: The covalently bound inhibitor as well as individual amino acids in the environment of the active center of the thrombin around Ser195 are depicted in the form of a stick model. Oxygen atoms are depicted in red, sulfur atoms in yellow, nitrogen atoms in blue, and carbon atoms in gray. Additionally, the inhibitor is overlaid by its 2F₀-F₀ electron density (outlined at 1σ). The inhibitor is clearly defined concerning its electron density.

In the experimentally determined electron density, the covalent bond of the PMSF at Ser195, which significantly differs from that of the benzamidine originally bound in the crystal, can be clearly seen (FIG. 4). Thereby, evidence has been offered that the approach of dripping picoliter drops onto a protein crystal by use of the free mounting system works.

FIG. 5:

The fission product Pro-Ile of the inhibitor diprotin A as well as individual amino acids in the environment of the active center of the DPIV around Ser630 are depicted in the form of a stick model. Oxygen atoms are depicted in red, nitrogen atoms in blue, and carbon atoms in gray. Additionally, the inhibitor as well as Ser630, which is covalently coupled to the inhibitor, is overlaid by its 2F₀-F₀ electron density (outlined at 1σ). The inhibitor is clearly defined concerning its electron density (FIG. 5).

From the used tripeptide having the sequence Ile-Pro-Ile, the C-terminal isoleucine is cleaved off while the dipeptide remains covalently linked with Ser630 and is not cleaved off. In this respect, diprotin A rather acts as a suicide substrate than as an inhibitor.

According to the present invention, a method, wherein the treatment according to the present invention of a freely mounted crystal with a device for generating microdrops is conducted in batch processing in order to be able to operate at high throughput on crystals to be complexed, further is subject of the present patent application. To this end, according to the present invention, firstly (a) the crystal/s, which is/are preferably freely mounted, is/are held ready.

This holding ready of the crystals until the next method step (b) is conducted can, for example, be realized by means of storage of the crystals in a deep-frozen state or, more preferably, in a sealed container (for example vials) in vapor balance with the crystallization liquid in order to ensure that the crystal/s remain/s intact until method step (b) is conducted. In method step (b), microdrops of a solution containing, for example, a ligand are applied onto the freely mounted crystals, as disclosed according to the present invention, in order to complex the crystal, for example, with a ligand. Subsequent to complexing, the crystals treated according to the present invention have to be stored in a method step (c) before in method step (d) the X-ray crystallographic examination can be conducted. The storage in step (c) of the method is typically conducted in deep-frozen state, preferably in liquid nitrogen.

Method steps (a) and (c), respectively, can be conducted, for example, in sample changers, like they are used in cryo crystallography, so-called autosamplers (for example distributed by Riken, Kouto, Japan, or X-Ray Research GmbH, Norderstedt, Germany). Herein, the samples are arranged on a sample carrier, which is horizontally shifted in order to be able to take up samples in batch processing by means of a device for taking up samples. Controlling is conducted automatically. Simultaneously, a device for deep-freezing is provided.

The present invention is described in more detail by way of the following Examples.

### EXAMPLES

### 1. Example

Binding of Phenylmethylsulfonyl Fluoride (PMSF) to Human a Thrombin

A thrombin crystal was mounted on the free mounting system by means of a loop at a previously determined initial humidity of 93%. Under a microscope, surplus reservoir buffer was cautiously removed from the loop by means of a strip of filter paper. The stability and the consistency of the size of the crystal, respectively, were monitored by means of the video system.

Subsequently, the piezo pipette was filled with a 100 mM solution of PMSF, a ligand (inhibitor) of thrombin, in isopropyl alcohol. Herein, a highly concentrated PMSF solution in an organic solvent was used.

Subsequently, the crystal was bombarded with individual drops (single shot mode) of the solution. The total volume dripped on approximately corresponded to the volume of the crystal, i.e. about 300 pl. In case of the very high concentration of PMSF used, this corresponded to an approximately 3- to 4-fold molar surplus of the inhibitor. Herein, the projection of the surface of the crystal was monitored after each dripping-on and it was waited until the surface remained uniform again before the next drop was applied. The individual parameters of the experiment can be seen in Table 1.

TABLE 1

| | |
|---|---|
| Initial humidity [% r.h.] | 93% |
| Size of drops applied [pl] | appr. 30 |
| Number of drops applied | 10 |
| Voltage [V] | 39.1 |
| Pulse amplitude [μs] | 450 |

After completion of dripping-on, the crystal was moistened with PFPE oil (perfluoropolyether) and shock-frozen in liquid nitrogen. The X-ray crystallographic data record was recorded on a rotating copper anode. Data processing was conducted by means of the programs XDS and XSCALE, refinement and manual model construction was conducted by means of the programs CNX and O. The statistics of data collection, processing, and refinement are given in Table 2. Despite dripping on pure solvent, the diffraction quality of the crystal was not influenced, as can be seen, in particular, on the basis of the value of Rₘₑₐₛ.

TABLE 2

| Inhibitor | PMSF |
|---|---|
| Irradiation source | rotating copper anode |
| Wavelength [Å] | 1.5418 |
| Detector | MAR imageplate |
| Temperature [K] | 100 |
| Space group | C2 |
| Cell parameters: | |
| a ? b ? c [Å] | 70.8; 72.8; 72.7 |
| α = γ = 90°; β [°] | 99.77 |
| Resolution [Å] | 2.57 |
| Independent reflexes | 10,892 |
| I/σ¹ | 7.3 (2.9) |
| Completeness¹ [%] | 91.7 (94.5) |
| Rₘₑₐₛ^{1,2} [%] | 11.8 (40.4) |
| R_{cryst}¹ [%] | 19.8 |
| R_{free}² [%] | 26.4 |

¹Values in brackets are valid for the outermost resolution shell
²Rₘₑₐₛ = □ |I_{obs} − <I> |/□ <I>

A graphical representation of the results of the X-ray crystallographic examination can be taken from FIG. 4.

### 2. Example

Binding of Diprotin A to Porcine Dipeptidyl Peptidase IV (DPIV)

The crystals of the DPIV exhibited only a very limited dispersion behavior in the native state. However, the achievable resolution of the crystals can only be substantially improved by means of humidity optimization with the free mounting system. In an optimized state with reduced humidity, the crystals are additionally characterized by increased stability and therefore are more suitable for soaking experiments by means of dripping-on.

In the present experiment, a crystal of the DPIV was mounted by means of the free mounting system at a previously determined initial humidity of 97%. For optimization, humidity was decreased in a gradient of 0.5% humidity alteration per 60 s down to 89% r.h. The transformation of the crystal, which is characterized by a significant increase in resolution, already starts at 94% r.h. and reaches its maximum at 89% r.h. Therefore, humidity was kept constant during dripping-on.

An inhibitor solution of aqueous diprotin A solution (50 mM) was used as ligand. With the use of an aqueous solution, smaller drop sizes can be achieved than in comparison with organic solvents, as a result of which the crystal is treated even more gently. During dripping-on of the solution, the surface of the crystal was permanently monitored and the next drop was only applied as soon as the surface did not change anymore. The total amount of inhibitor dripped on corresponds to an approximately 10-fold molar surplus. The individual parameters of the experiment can be taken from Table 3.

TABLE 3

| | |
|---|---|
| Initial humidity [% r.h.] | 97 |
| Humidity gradient | 0.5%/60 s |
| Optimum of humidity [%] | 89 |
| Size of drops applied [pl] | appr. 5-10 |
| Number of drops applied | 80 |
| Voltage [V] | 39.2 |
| Pulse amplitude [μs] | 10 |

After completion of dripping-on, the crystal was moistened with PFPE oil (perfluoropolyether) as cryo protectant and frozen in liquid nitrogen. The subsequent recording of an X-ray crystallographic data record was conducted on a rotating copper anode.

Data processing was conducted by means of the programs XDS and XSCALE, refinement and manual model construction were conducted by means of the programs CNX and O. The statistics of data collection, processing, and refinement are given in Table 4.

TABLE 4

| Inhibitor | diprotin A |
|---|---|
| Irradiation source | rotating copper anode |
| Wavelength [Å] | 1.5418 |
| Detector | MAR imageplate |
| Temperature [K] | 100 |
| Space group | Pl |
| Cell parameters: | |
| a ? b ? c [Å] | 62.3; 118.5; 133.1 |
| α ? β ? γ [°] | 112.7; 94.9; 90.9 |
| Resolution [Å] | 2.59 |
| Independent reflexes | 103,898 |
| I/σ¹ | 14.0 (4.1) |
| Completeness¹ [%] | 93.5 (89.4) |
| Rₘₑₐₛ^{1,2} [%] | 6.1 (28.0) |
| R_{cryst}¹ [%] | 22.6 |
| R_{free}² [%] | 27.5 |

The results of the X-ray crystallographic examination are depicted in FIG. 5. This Example clarifies the considerable potential of methods according to the present invention using micro dosage systems (and free mounting), as herein a crystal could be optimized and an inhibitor could be bound by means of dripping-on in a parallel manner.

### 3. Example

Binding of Pefabloc to Human α-Thrombin by Means of Slow Accumulation

A further possibility of binding, in particular, hardly soluble ligands (inhibitors) to crystallized proteins is the slow accumulation of the inhibitor, which is solved in an aqueous system. In the case of classic soaking, one is always depending on the concentration of the inhibitor in the solution not being too low. Therefore, it is often necessary to add solvent to the setup in order to increase solubility, which can damage or even destroy the sensitive protein crystals.

By means of a device according to the present invention and in the conduction of a method according to the present invention, respectively, solvents were completely omitted for reasons of a gentler treatment, as, even with only weak solubility, the inhibitor accumulates in the crystal due to frequent dripping-on, whereby the probability of binding is substantially increased. By monitoring the crystal on the video system, it was ensured that the crystal was not moistened too intensely. A new drop was only applied after the previous drop had already evaporated. Even the number of drops to be applied could be calculated from the information on the solubility of the relevant inhibitor, the drop size, and the number of molecules in the crystal.

Pefabloc SC (4-(2-aminoethyl)-benzenesulfonyl-fluoride-hydrochloride, Kᵢ: 6.5 μM) was used as inhibitor, which is characterized by high stability in an aqueous system.

The number of drops required for a stoichiometry of inhibitor to protein of 2:1 was calculated under the following constraints: with a crystal volume of 300 pl and a density of the crystal of about 1.3 g/ml, 390 ng resulted for the mass of the crystal. Considering the molecular weight of thrombin (about 40 kD) resulted in a concentration of thrombin in the crystal of about 9.75 pmol/300 μl or 32.5 mM. As it was envisaged to apply the inhibitor at a stoichiometric ratio of 2:1 in order to achieve an occupation as high as possible, the amount of inhibitor required was 19.5 pmol (9.75 pmol×2).

The amount of inhibitor solution to be dripped on depends on the concentration of the inhibitor and was selected experimentally for three concentrations assuming a drop size of 10 pl, as it is feasible with the use of water, as is depicted in Table 5. With a conventional relative humidity between 90 and 100% r.h., one drop per second could be applied onto the crystal sequentially. However, the frequency was significantly increased, if, in case of reduced humidity in the sheath stream, which leads to desiccation of the crystal, the loss of humidity had to be balanced by means of more frequent dripping-on and therefore the relative humidity at the crystal had to be kept constant. Thereby, a frequency of 20 drops per second was possible. The times resulting therefrom at different inhibitor concentrations are also depicted in Table 5.

TABLE 5

| | Total volume of | | Duration of the |
|---|---|---|---|
| Inhibitor | solution to be | Number of drops | experiment [h] |
| concentration | dripped on [μl] | (drop volume 10 pl) | at 20 drops/sec |
| 100 μM | 0.195 | 19,500 | 0.3 |
| 10 μM | 1.95 | 195,000 | 2.7 |
| 1 μM | 19.5 | 1,950,000 | 27.1 |

In the experiment with human α-thrombin and the inhibitor Pefabloc using a concentration of 100 μM, the following experimental parameters, which can be taken from Table 6, were selected. By means of increasing the frequency of dripping-on, the reduced humidity could be balanced during the experiment.

TABLE 6

| | |
|---|---|
| Initial humidity [% r.h.] | 93 |
| Humidity during dripping-on [% r.h.] | appr. 80 |
| Inhibitor concentration [μM] | 100 |
| Size of protein crystal [pl] | 250 |
| Size of drops to be applied [pl] | appr. 10 |
| Frequency [s⁻¹] | 10 |
| Number of drops to be applied | 17,000 |
| Voltage [V] | 41.0 |
| Pulse amplitude [μs] | 450 |

1. A device for treating a crystal with a liquid comprising a holder for fixing the crystal and at least one micro dosage system, which is arranged in relation to the holder in such a way that it allows applying microdrops of the liquid onto the crystal fixed in the holder.

2. The device according to claim 1, which furthermore comprises a device capable of generating a defined environment around the crystal during dripping-on of the liquid.

3. The device according to claim 2, wherein the generation of the defined environment is the generation of a gas stream of defined composition around the crystal.

4. The device according to claim 3, wherein the holder is developed in such a way that the gas stream can be led through the holder in such a way that it is directed toward the crystal fixed in the holder.

5. The device according to claim 1, wherein the holder consists of a carrier block for a holder capillary having a free support end for the crystal.

6. The device according to claim 5, wherein the holder capillary consists of a micro pipette, wherein a negative pressure can be generated in order to hold the crystal.

7. The device according to claim 5, wherein the carrier block of the holder contains an integrated gas channel having a mouth end, which is directed toward the support end of the holder capillary.

8. The device according to claim 3, further comprising a gas mixing device, by means of which the composition of the gas stream can be adjusted variably.

9. The device according to claim 8, wherein the gas consists of air having a specific humidity content and the gas mixing device capable of adjusting the air humidity.

10. The device according to claim 3, further comprising a device for adding a solubilizer, by means of which a solubilizer for a substance to be introduced into the crystal structure of the crystal can be added to the gas stream.

11. The device according to claim 10, further comprising a device for adjusting the concentration of the solubilizer.

12. The device according to claim 3, further comprising a temperature adjusting device capable of variably adjusting the temperature of the gas stream.

13. The device according to claim 1, wherein the micro dosage system is developed in such a way that it can generate microdrops of the liquid to be applied onto the crystal, which have a volume that is smaller than the volume of the crystal.

14. The device according to claim 13, wherein the micro dosage system is developed in such a way that it can generate microdrops having a volume of between 10 and 20 percent of the volume of the crystal and preferably between 5 and 10 percent of the volume of the crystal.

15. The device according to claim 11, wherein the micro dosage system is developed in such a way that it can generate microdrops having a volume of between 1 nl and 100 pl, preferably between 100 pl and 20 pl, and also preferably between 20 pl and 4 pl.

16. The device according to claim 1, wherein the micro dosage system further comprises a liquid supply system, by means of which different liquids to be dripped onto the crystal can be led to a drop generating part of the micro dosage system in a time-dependently controlled manner.

17. The device according to claim 16, wherein the liquid supply system of the micro dosage system comprises an electrically controllable precision syringe and a duct system capable of connecting the precision syringe can be connected with different liquid supply containers and with the drop generating part of the micro dosage system, in order to feed liquid for drop generation to the latter.

18. The device according to claim 1, wherein the micro dosage system is developed in such a way that it comprises a piezo pipette forming the drop generation part.

19. The device according to claim 18, wherein the piezo pipette consists of a capillary, which is enclosed by a piezoelectric element.

20. The device according to claim 18, wherein the micro dosage system furthermore comprises a controlling device electrically connected with the piezo pipette, which is developed in such a way that it allows applying differently shaped voltage pulses, whose shapes regulate the shape and size of the microdrops and whose frequency regulates the frequency of the microdrops, to the piezo pipette.

21. The device according to claim 1, wherein the micro dosage system comprises a capillary and a micro valve arranged inside the capillary.

22. The device according to claim 21, wherein the micro dosage system furthermore comprises a controlling device for switching the micro valve on and off in order to generate the microdrops.

23. The device according to claim 1 comprising several micro dosage systems, which are, in relation to the holder, arranged in such a way that they allow applying microdrops of different liquids onto the crystal fixed in the holder.

24. The device according to claim 1, wherein the holder is furthermore developed in such a way that it is suitable for fixing a protein crystal.

25. The device according to claim 1, wherein the liquid consists of a solution.

26. The device according to claim 21, wherein one or more substance/s to be introduced into the structure of the crystal or to react with the latter is solved in the solution.

27. The device according to claim 26, wherein the one or more substances consists of one or more ligands or inhibitors.

28. The device according to claim 26, wherein the one or more substances contains one or more reactants, which can react with or in the protein crystal.

29. The device according to claim 25, wherein the solution consists of water, wherein a substance is solved, which can interact with the protein crystal.

30. The device according to claim 29, wherein the substance consists of an inhibitor or a ligand, which is only hardly soluble in water.

31. The device according to claim 1, wherein the liquid contains a cryo buffer.

32. The device according to claim 1, wherein the crystal in the holder is not arranged in a liquid, for example the mother solution.

33. A goniometer head having a device according to claim 1.

34. An X-ray irradiation installation having a device according to claim 1.

35. A synchrotron irradiation installation having a device according to claim 1.

36. A method for treating a crystal with a liquid having the following steps:
fixing the crystal without being surrounded by a liquid environment; and
applying microdrops of the liquid onto the crystal.

37. The method according to claim 36, wherein defined environment is generated around the crystal during the dripping-on of the microdrops.

38. The method according to claim 37, wherein generating a defined environment comprises generating a gas stream having a defined composition around the crystal.

39. The method according to claim 38, wherein the gas stream consists of an air stream of regulated air humidity.

40. The method according to claim 38, wherein the gas stream is regulated during dripping-on.

41. The method according to claim 39, wherein the air humidity of the gas stream and the frequency, at which the drops are dripped onto the crystal by means of the micro dosage system, are coordinated during dripping-on in such a way, that the crystal is strained as little as possible, in particular that the volume of the crystal changes by no more than 20%, in particular no more than 10%.

42. The method according to claim 38, wherein the gas stream comprises a solubilizer of regulated concentration for a substance to be applied onto the crystal.

43. The method according to claim 36, wherein the volume of the microdrops is smaller than the volume of the crystal.

44. The method according to claim 43, wherein the microdrops of the solution have a volume between 1 nl and 100 pl, preferably between 100 pl and 20 pl, and also preferably between 20 pl and 4 pl.

45. The method according to claim 36, wherein the crystal is a protein crystal.

46. The method according to claim 36, wherein the liquid consists of a solution, wherein the solution is optionally heated to a temperature higher than 20° C.

47. The method according to claim 46, wherein the solution contains one or more substance/s containing one or more ligand/s and/or inhibitor/s.

48. The method according to claim 46, wherein the solution consists of water or an organic solvent or a mixture of one or more organic solvents and/or water, in which a substance is contained, which is supposed to interact with the protein crystal.

49. The method according to claim 47, wherein the substance consists of an inhibitor or ligand, which is only hardly soluble in water.

50. The method according to claim 36, wherein the liquid consists of a cryo buffer.

51. The method according to claim 38, wherein the gas stream contains one or more substances containing one or more ligands and/or inhibitors.

52. The method according to claim 36, wherein the crystal is vapor-plated with solvent, in particular organic solvent, by means of an evaporator.

53. A method for determining a protein crystallographic structure, optionally a complex of a protein and a substance, wherein the method steps according to claim 36 are conducted and furthermore the crystal is irradiated with X-ray or synchrotron radiation and the diffraction image of the crystal is recorded.

54. The method according to claim 53, wherein the irradiation occurs during the treatment of the crystal with the liquid.

55. The method according claim 53, further comprising determining the intensities of the reflexes of the diffraction image.

56. The method according to claim 53, further comprising determining the electron density of the crystal structure by use of the phase information, for example from isomorphic substitution or MAD (multiple anomalous scattering).

57. A method for identifying ligands binding a crystallized protein, wherein (a) a potential ligand is applied onto the crystal by means of a method according to claims 36, (b) diffraction intensities are measured at intervals of variable length, and (c) said diffraction intensities measured at intervals are compared with respect to their time-dependent sequence.

58. A method for X-ray crystallographic structure determination at high throughput, wherein (a) one or more crystals is held ready, preferably in a freely mounted manner, (b) microdrops of a solution containing, for example, at least one ligand are applied onto the preferably freely mounted crystals, (c) the crystals treated according to method step (b) are stored, and (d) the crystals are examined X-ray crystallographically.
